(19) United States
(12) Patent Application Publication
(10) Pub. No.: US 2010/0153839 A1
(43) Pub. Date: Jun. 17, 2010

(54) SYSTEM AND METHOD FOR CREATING WEB-BASED APPLICATION TEMPLATES

(76) Inventor: David Wilkins, Montreal (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 12/634,017

(22) Filed: Dec. 9, 2009

Related U.S. Application Data
(60) Provisional application No. 61/121,339, filed on Dec. 10, 2008.

(51) Int. Cl. G06F 3/01; G06F 17/00

(52) U.S. Cl. 715/235; 715/731; 715/760

(57) ABSTRACT

A method, system and software program on a computer readable medium are provided, for generating a template compatible with Microsoft Silverlight. An authoring application can be used that provides access to a Microsoft PowerPoint slide, permitting objects to be added to the slide. The authoring application also permits properties of the objects to be defined and then converts the objects to a format associated with Silverlight (XAML) to generate a template, and generates metadata defining the properties for application of the properties to said template.

### CROSS-REFERENCE TO RELATED APPLICATIONS

This application claims priority from U.S. Patent Application No. 61/121,339 filed Dec. 10, 2008, the contents of which are incorporated herein by reference.

### TECHNICAL FIELD

The following relates to systems and methods for creating web-based application templates, and has particular utility in generating Microsoft® Silverlight™ templates using Microsoft® PowerPoint®.

### BACKGROUND

Microsoft's Silverlight™ cross-platform web technology is a development toolkit for programmers and graphic artists to create rich multimedia web applications that will run in any Internet web browser on any operating system on any hardware platform. Until now, Silverlight™ users have had no choice but to use the Microsoft® Expression® application suite to develop their Silverlight™ projects. The tools in the Expression® suite are very powerful, however, the cost of such power is that use of the suite requires a significant level of graphics, animation, and programming skills. This has made it difficult for casual non-technical users to create their own Silverlight™ applications.

It is therefore an object of the following to address the above-noted disadvantages.

### SUMMARY

In one aspect, there is provided a method for generating a template compatible with Microsoft® Silverlight™ comprising providing access to a Microsoft® PowerPoint® slide; permitting objects to be added to the slide; permitting properties of the objects to be defined; converting the objects to a format associated with Silverlight™ to generate a template; and generating metadata defining the properties for application of the properties to the template.

In another aspect, there is provided an authoring application embodied as a software application executing instructions stored on a computer readable medium for performing the method.

In yet another aspect, there is provided a system comprising a web control interface, a multimedia player, and a database storing one or more templates created according to the method above.

### BRIEF DESCRIPTION OF THE DRAWINGS

Embodiments of the invention will now be described by way of example only with reference to the appended drawings wherein:

FIG. 1 is a block diagram illustrating a system for authoring, generating, and playing Silverlight™ templates using PowerPoint® as a graphics tool.

FIG. 2 is a block diagram of a Smart Object.

FIG. 3 is a screen shot illustrating an example user interface (UI) for the authoring application shown in FIG. 1.

FIG. 4 is a screen shot illustrating an example UI for the Silverlight™ player shown in FIG. 1.

FIG. 5 is a screen shot illustrating an example UI for a web control page.

FIG. 6 is a flow diagram illustrating exemplary operations performed in generating a Silverlight™ template using the authoring application.

FIG. 7 is a flow diagram illustrating exemplary operations for performing the conversion step shown in FIG. 6.

FIG. 8 is a flow diagram illustrating exemplary operations performed in broadcasting media content using a Silverlight™ template.

FIG. 9 is a schematic diagram showing a conversion logic table stored in memory and accessed by a conversion tool.

### DETAILED DESCRIPTION OF THE DRAWINGS

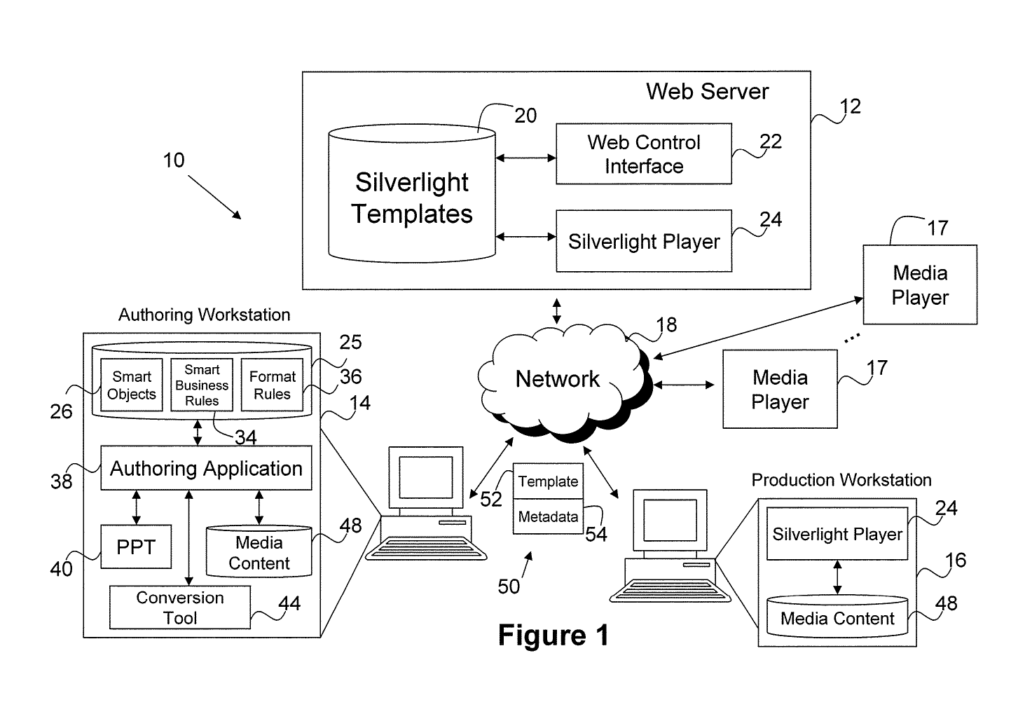

Turning to FIG. 1, a system for authoring, generating, and playing Silverlight™ templates using PowerPoint® as a graphics tool is generally denoted by numeral 10 and may hereinafter be referred to as “the system 10”. In the embodiment shown in FIG. 1, the system 10 comprises a web server 12, an authoring workstation 14 and a production workstation 16, such workstations 14, 16 being communicably connectable to the web server 12 over a network 18. Also connected to the network 18 and thus capable of communicating with the web server 12, authoring workstation 14, and production workstation 16, is one or more media players 17 capable of playing media content 48. An arbitrary number of media players 17 are shown in FIG. 1 independent of a particular platform for illustrative purposes only and the media players 17 can be deployed on any suitable platform, such as a desktop or laptop computer, smart phone, cell phone, television (e.g. set top box or other processing module), etc. The authoring workstation 14 and production workstation 16 are shown separately for ease of explanation only and it will be appreciated that a single entity (not shown) may also be used to provide the capabilities of both workstations 14, 16, e.g. at a single location. Similarly, although the web server 12 is shown as being separate from the workstations 14, 16, it will be appreciated that the web server 12 and workstations 14, 16 may be implemented at any one or more locations by one or more entities in any suitable configuration.

The web server 12 in this embodiment provides a central cache or database 20 of Microsoft® Silverlight™ templates 52 that can be centrally stored and controlled by a web control interface 22. The templates 52 are custom, reusable objects based on the Silverlight™ platform that enable intelligence to be incorporated into a Silverlight-based multimedia display.

Silverlight™ is, generally speaking, a development toolkit for programmers and graphic artists to create rich multimedia web applications. Silverlight™ provides a retained mode graphics system similar to Windows® Presentation Foundation, and integrates multimedia, graphics, animations and interactivity into a single runtime environment. Silverlight™ works in conjunction with Extensible Application Mark-up Language (XAML) and is scriptable with JavaScript. XAML can be used for marking up the vector graphics and animations. Textual content created with Silverlight™ is searchable and indexable by search engines as it is not compiled, but represented as text (XAML). Silverlight™ can also be used to create Windows® Sidebar gadgets for Windows® Vista.

Silverlight™ supports playback of WMV, WMA and MP3 media content across all supported browsers without requiring Windows Media Player®, the Windows Media Player ActiveX® control or Windows Media browser plugins. Silverlight™ makes it possible to dynamically load XML content that can be manipulated through a DOM interface, a technique that is consistent with conventional Ajax techniques. Silverlight™ exposes a Downloader object which can be used to download content, such as scripts, media assets or other data, as may be required by the application.

A Silverlight™ application starts by invoking the Silverlight™ control from the HTML page, which then loads up a XAML template file 52. The XAML file 52 contains a Canvas object, which acts as placeholder for other elements. Silverlight™ provides various geometrical primitives like lines, ellipses and other shapes, to elements like text, images, and media etc. The elements are properly positioned to achieve the desired layout. Any arbitrary shape can be created as well. These elements can be animated using event triggers; some animation effects are predefined, others can be created as composite of the pre-defined effects. Events like keyboard or mouse movements can also raise events which can be handled by custom scripts.

The web server 12 also comprises a Silverlight™ compatible renderer or “player” 24, which is a custom application capable of rendering and displaying Silverlight™ templates 52 created using the authoring application 38 based on the Silverlight™ platform. The player 24 can be a web-based player, i.e. such that templates 52 are played on a remote web browser using the player 24 residing on the web server 12; or may represent a downloadable file to make available client versions of the Silverlight™ compatible player 24. The web control interface 22 enables central control of what viewers would see on local web browser screens, e.g. on a set of remote media players 17.

The authoring workstation 14 is any entity or device that comprises an authoring application 38 for generating Silverlight™ templates 52. As will be explained in greater detail below, the authoring application 38 allows non-technical users to create full multimedia applications in Microsoft's Silverlight™ platform by building custom templates directly inside a familiar program such as the Microsoft PowerPoint® interface (PPT 40). In this way, any user familiar with PowerPoint® can quickly build advanced data-driven multimedia applications in a relatively short amount of time, using tools and concepts they already know. This can dramatically shorten the learning curve associated with using Silverlight™ and allows multimedia developers to quickly create and deploy advanced web applications without having to worry about the technical details associated with the Silverlight™ development platform. The authoring application 38 accomplishes this by extracting objects, elements, features, and intelligence built into a template created in PPT 40 and, using a conversion tool 44, generates a new custom Silverlight™ template 52 with corresponding features and intelligence. The conversion tool 44 represents any module or set of computer executable instructions for performing the conversion from PPT 40 format to Silverlight™ template 52 format. The template in PPT 40 is created in order to arrange and present media content 48 in a multimedia application, that is to ultimately be presented in the Silverlight™ template 52 in a similar manner.

In addition to permitting objects and features to be added to PPT 40 from scratch (i.e. using existing text, graphics etc.), the authoring application 38 can utilize smart objects 26 to build intelligence into the template 52 by reusing already prepared objects having been created with built-in intelligence. The objects, elements and features built into PPT 40, either from scratch or using smart objects 26, facilitate the creation of meta data 54 that is appended to the template 52. In this way, certain properties and parameters defined by the user or existing in a smart object 26 can be inherited by the templates 52 such that by modifying a smart object 26, a template 52 can also be modified. This allows standard objects 26 to be created that can change for each and every instance and use of the object 26 and template 52 for different applications. The smart objects 26 can be stored in the authoring application's database or library 25 along with the smart business rules 34 and formatting rules 36. It may be noted that the smart objects 26, smart business rules 34, and formatting rules 36 can be existing elements that are added and modified in PPT 40 to more efficiently create the templates 52 compatible for Silverlight™ but similar elements can also be created, defined and modified from scratch using the inherent capabilities of PPT 40. As such, the smart objects 26, smart business rules 34, and formatting rules 36 can be used as tools to expedite the creation of a template 52 but are not required to create such a template 52 using PPT 40.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the web server 12, authoring workstation 14, production workstation 16, media player 17, etc., or accessible or connectable thereto. Any application or module herein described may be implemented using computer readable/executable instructions that may be stored or otherwise held by such computer readable media.

Smart objects 26 can be used to form building blocks needed to create multimedia web displays, layouts, digital signage etc. and, as discussed above, can be incorporated directly into the Silverlight™ template 52 using PPT 40. Smart business rules 34 allow a template 52 to automatically reconfigure itself based on a changing data condition (e.g. automatically play an umbrella commercial when it is raining outside). It may be noted that smart business rules 34 may also be incorporated into the smart objects 26 and are only shown as separate items for ease of explanation. The formatting rules 36 allow dynamic information to be automatically modified based on predefined format specifications (e.g. maximum length of a text object, change upper case text to lower case, etc.). It can be appreciated that the formatting rules 36 can also be incorporated into the smart objects 26 in some embodiments.

The use of smart components greatly reduces the need for specialized training on the part of the end user. Whereas in prior systems a user required a certain minimum level of competency as a graphic artist or software developer, the introduction of smart components allows users without any specialized knowledge to quickly and easily create complete video graphics digital signage applications that combine real-time information sources with dynamic display characteristics.

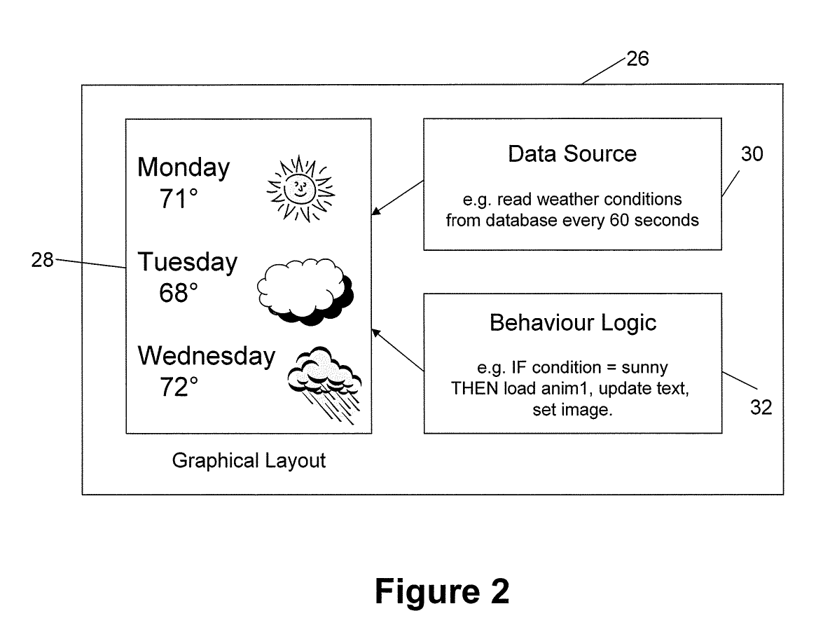

As can be seen in FIG. 2, the smart object 26 includes a graphic layout 28, data source 30 and behaviour logic 32 to provide conditions for updating content provided by the object 26. These self-contained components can be used to generate a portion of a display, such as a weather or stock ticker, or an entire full-screen video output comprising multiple elements, each with its own set of data sources and individual behaviours. Multiple smart objects 26 can be included in a template 52, and multiple templates 52 can be created from a library of smart objects 26.

Smart objects 26 in this example, may include the following basic characteristics: 1) an object 26 can contain an unlimited number of graphical elements, including text, images, animations, and video; 2) multiple objects 26 can be used simultaneously to form a composited rich media final output; 3) each object 26 is entirely self-contained, including all of the graphical and video elements, data sources, and business rules needed to generate a final output; and 4) objects 26 can be self-configuring, allowing the output to be dynamically modified in response to data triggers, without the need for user intervention. An example of this is a weather graphics that automatically displays a cloud animation when it is cloudy or a sun animation when it is sunny, or a financial graphic that shows a red downward pointing arrow when the stock market is down or a green up arrow when the market is up.

The smart objects 26 are considerably powerful for the end user, since it not only encompasses an object's graphical elements 28, but also the rules or behaviour logic 32 which define how the graphical elements will respond to continuously changing inputs from the data sources 30. A typical example of using smart objects 26 involves retail displays installed in a department store. A display could be configured to display a continuous loop of video, images, and promotional text associated with the specials of that week. A smart object 26 within the display layout can be designed to integrate with the department store's inventory management system. If the inventory level for any of the items displayed on the screen falls below a minimum threshold, the object automatically switches to an alternative set of specials on items for which inventory is available. Without smart objects 26, this example would require custom software development for each screen layout that is required. With smart objects 26, the rules are defined once, and then reused again and again for any number of screen layouts. Also, the behaviour logic 32 can be used to interrelate multiple objects 26 such that an event relevant to one object 26 triggers a change in another object 26. Using the above example, in a retail environment, a change in the weather, e.g. it begins to rain can trigger a change in advertising for merchandise, e.g. rain wear or umbrellas.

To use an object 26 to create a portion of a final video output, a user can simply drag and drop the component from a browser window (organized in the template generator 12) onto the workspace, or “canvas” (provided by the graphics program such as PPT 40). The component's graphical elements and layout, as well as any internal logic and business rules, are automatically added to the canvas. By dragging and dropping multiple objects 26 onto the canvas, a user can create a complete finished layout in a matter of seconds. This results in much more than a simple graphics layout. When the layout is displayed on a video screen, each of the components automatically configures itself and automatically displays live graphics and video information based on its internal logic 32 and behaviour definitions.

Typical examples of smart objects include: 1) weather objects showing real-time weather conditions; 2) sports tickers showing live sports results; 3) headline tickers that continuously scroll live news information; 4) video windows that automatically play through a loop of video content; and 5) alert pop-ups that automatically appear in the event of a fire alarm or weather warning.

The metadata 54, which is appended to or in any event associated with a particular template 52, is a secondary file that defines the behaviours, formatting and business rules associated with the template 52. This file is advantageously an extensible mark-up language (XML) file. The template 52 and accompanying metadata 54 may collectively be referred to as a template data package 50.

The production workstation 16 in this embodiment represents any entity or device that utilizes templates 52 generated by the authoring application 38 and media content 48 that can be cached or stored locally or accessed from the web server 12 or authoring workstation 14, to display the media content 48 through the template 52 using a player 24. It can be appreciated that the production, authoring and broadcasting (media player) environments are not necessarily separate as shown in FIG. 1 but may be provided in different configurations. The following examples will exemplify the creation of a template data package 50 at an authoring workstation 14 using the authoring application 28; the combining of a template 52, metadata 54, and media content 48 at a production workstation 16; and the broadcasting or “playing” of the media content 48 using the template 52 and metadata 54 on one or more media players 17, under control of instructions generated at and sent to the media players 17 from the web control interface 22. Again, any of these operations may be performed in any combination from any one or more locations with suitable and equivalent capabilities.

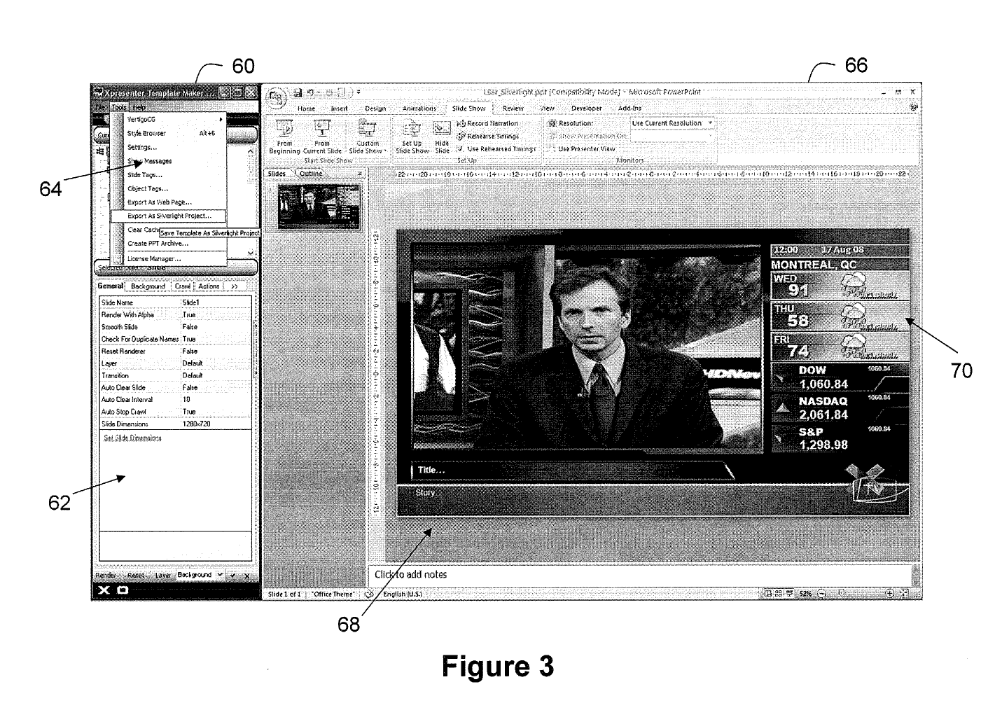

A user interface (UI) 60 for the authoring application 38 is shown in FIG. 3. The UI 60 comprises a navigation pane or property window 62, which can be used to add further properties to an element added to a PPT slide 66. This allows multimedia capabilities to be set that add intelligence to any element added and extend the native properties of the element for behaviours such as font, upper/lower case, colours, timing, etc. The elements may comprise smart elements 70 derived from smart objects 26 and/or native PPT elements such as text, images etc. added in PPT 40 directly by the user. The property window 62 also enables a menu 64 to be invoked in order to perform various functions such as exporting the PPT slide 68 as a Silverlight® template 52. The property window 62 enables an element, once inserted into the slide 68, to be modified and various parameters set to suit the particular application and define the multimedia behaviours of that element.

The authoring application 38 can provide various features and capabilities. For example, it should provide support for all PPT text and image creation features, as well as support for standard PPT WordArt and ClipArt features. The authoring application 38 also provides the ability to combine multiple video windows in a single template, point-and-click linking of slide objects to live data sources and network databases, advanced keyframe animation editing capabilities, automatic conversion of graphic elements to supported Silverlight image formats, one-click publishing of an entire Silverlight™ project to a web server 12, support for multiple simultaneous crawling news tickers, support for 3D animations, support for streaming video feeds, and the ability to control Silverlight™ web content from a central control station (e.g. web control interface 22). As noted above, a library of smart Objects 26 can be used, which are reusable elements for common functions, such as weather tickers, news crawls, stock market tickers, etc. Support for smart business rules 36 is also provided, allowing a template to automatically reconfigure itself based on a changing data condition (eg., automatically play an umbrella commercial when it is raining outside). Similarly, automatic formatting rules 36 can be used to allow dynamic information to be automatically modified based on predefined format specifications (eg., maximum length of a text object, change upper case text to lower case, etc).

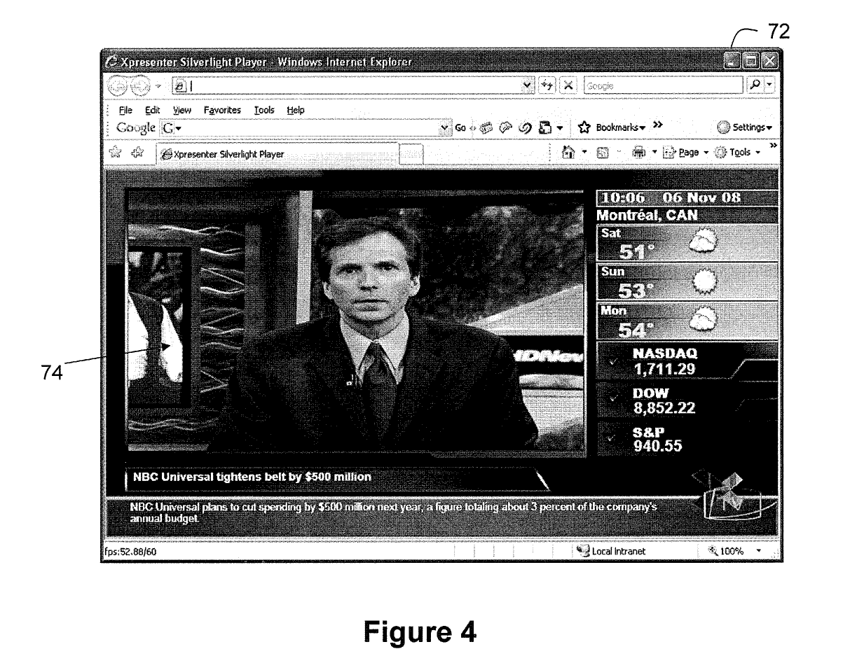

An example of a typical UI 74 for a Silverlight™ template 52 is shown in FIG. 4. The template's UI 74 is shown loaded in a standard web browser 72, and features live video playback, real-time data tickers, and animated elements that play dynamically on the screen. In this application, the template 52 is used as an online information channel, automatically updating live information to anyone that has loaded the template in their web browser 72, e.g. at the production workstation 16 or any media player 17.

The templates 52 provide a tool for building various channels to deliver content to one or more users. Such channels include corporate news channels, training channels, department channels, employee channels, customer channels, digital signage channels, interactive channels, desktop channels, and mobile channels. A digital signage channel uses a template 52 to define a format for delivering various media through a fully configurable (and changeable or dynamic) signage. For example, video, static text and moving text can be incorporated into a customized template 52. Interactive channels enable a user to make selections and otherwise interact with a specially configured digital signage application, e.g. for wayfinders and event calendars or for demonstrations and training. Desktop channels enable a desktop communications platform to be created to effect an enterprise-wide desktop communication system, which may include desktop television and alert applications. For example, each employee can be provided with their own live information channel running on their desktop computer. A communications department can target any screen, group of screens or all screens at the same time and users can “tune” to different channels and customize what information they see and how. Similarly, mobile channels can be developed to deliver and play content on a mobile device such as a smart phone. It can therefore be appreciated that the flexibility provided by the templates 52 and the ease in developing same provides a useful tool in developing many different environments and applications.

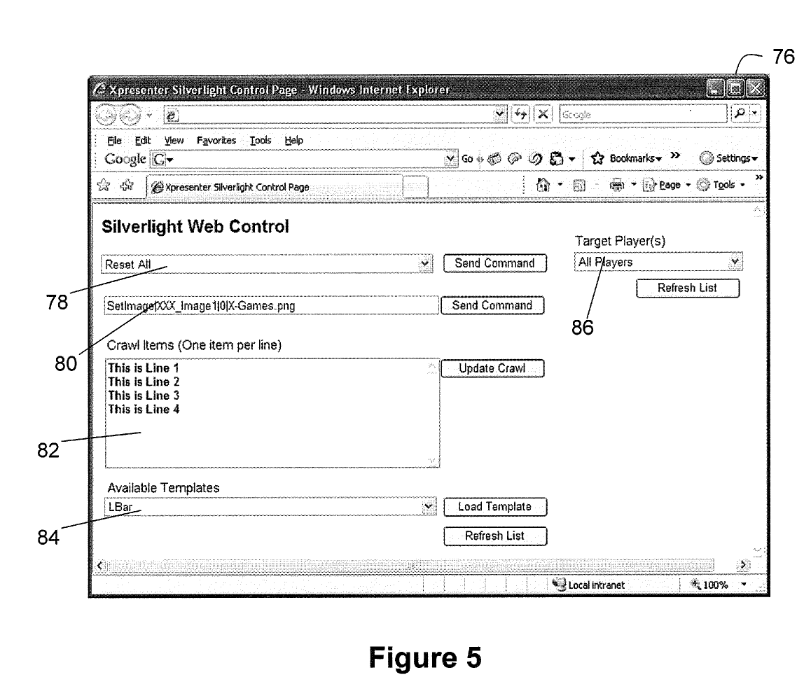

FIG. 5 provides an example UI 76 for the web control interface 22. This UI 76 allows users in a central location (e.g. through web server 12) to control what viewers see on their local web browser 72. The UI 76 provides various options for sending commands and thus controlling the web application utilizing the templates 52 and various examples are shown in FIG. 5 for illustrative purposes only. A pull-down command menu 78 can be used to select from a list of commands to send to one or more target players, selected using a players pull-down list 86. Other commands or instructions can be identified using a free-form command entry box 80 and such commands sent to the selected players 17. Custom command options such as the crawl items command box 82 can also be defined to allow commands specific to a particular element (in this case a crawl) to be readily defined and sent. A template pull-down list 84 is also provided, which enables various templates available to the UI 76 to be accessed and used to update the selected players 17.

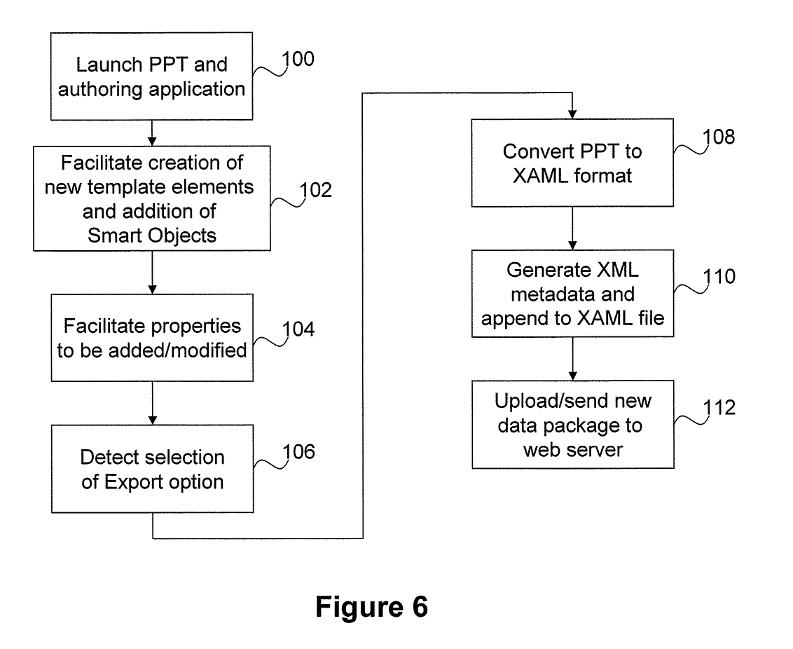

Turning now to FIG. 6, a sequence of operations that may be executed at the authoring workstation 14 using the authoring application 38 is shown. At 100, PPT 40 and the authoring application 38 are launched. It will be appreciated that the authoring application 38 and PPT 40 are preferably launched at the same time, together in a single instance, either by loading PPT 40 or the authoring application 38. The authoring application 38 then facilitates the creation of a new template in PPT 40 by enabling elements to be created in PPT 40 and/or smart objects 26 and other predefined objects to be added, modified, etc. at 102. This can be done by providing drag and drop capabilities to adding objects/elements to the PPT slide 68, or various menu options either in the authoring application 38 or within PPT 40. At 104, the authoring application 38 also permits (during and after insertion of the elements) further properties and intelligence for the elements inserted into PPT 40, to be added and/or modified, which forms the basis for the metadata 54 to accompany the new Silverlight™ template 52 being created. The user may then select an export option from the menu 64 from which, at 106, the authoring application 38 detects such selection. The authoring application 38 would then convert the PPT slide 68 and its elements, to XAML format thus creating a Silverlight™ template 52 at 108. The XML metadata 54 may then be generated at 110 and appended to the XAML file representing the template 52, and the data package 50 thus formed. The new data package 50 is then sent, uploaded, downloaded or otherwise provided to the web server 12 at 112.

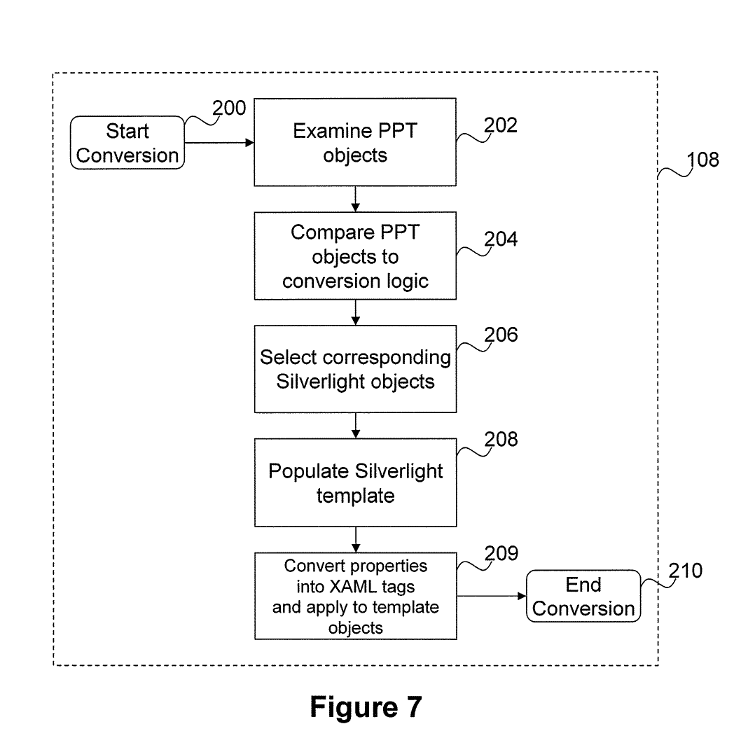

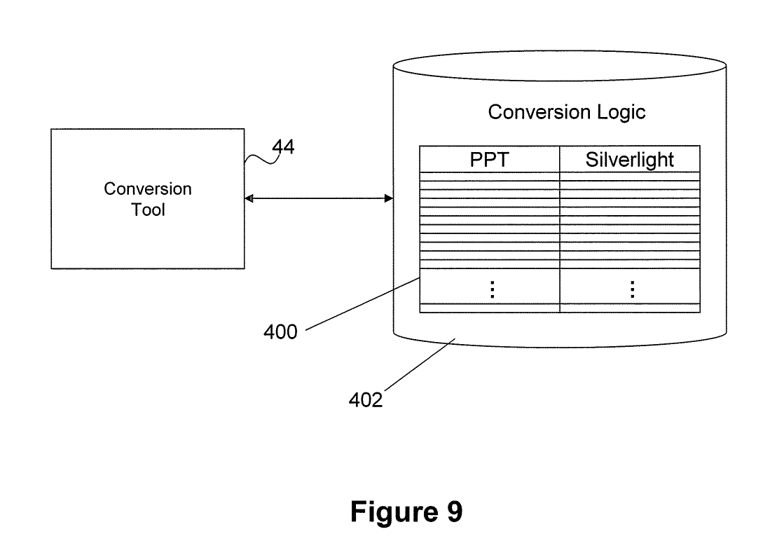

The conversion from a PPT slide 68 to a Silverlight™ template 52 represented by step 108 in FIG. 6 involves creating an equivalent to the features (and their properties) applied to the PPT slide 68 in the Silverlight™ template 52. FIG. 7 illustrates an example sub-routine performed at step 108. At 200 the conversion sub-routine begins by calling a function or otherwise initiating a set of instructions. At 202, the PPT objects, elements, features, and characteristics of the PPT slide 68 are examined and compared to conversion logic (e.g. a conversion table 400 stored in a memory 402 as illustrated in FIG. 9) or other set of criteria at 204, which determines equivalent features to be created in the XAML format for the Silverlight™ template 52. The corresponding Silverlight™ objects, features, etc. are then selected at 206 and populated in a new Silverlight™ template 52 at 208. The properties and intelligence defined in the PPT elements are then converted to XAML tags and applied to the template objects. Once the conversion is complete, the sub-routine ends at 210.

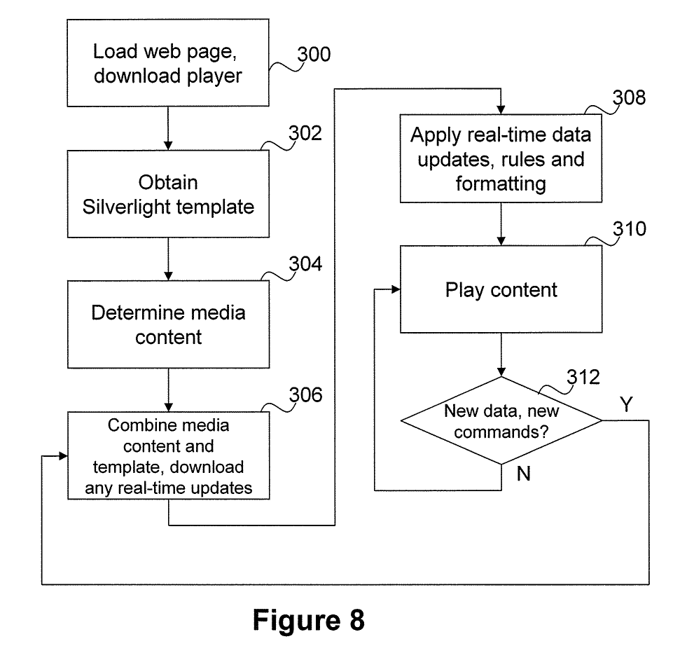

FIG. 8 illustrates a sequence of operations that may be performed by the Silverlight™ player 24, e.g. on the web server 12, at a production workstation 16, and/or on a media player 17. For this example flow chart, it is assumed that the entity running the player 24 stores or has access to the media content 48 to be combined with the Silverlight™ template 52, metadata 54, and access to real-time live data updates for broadcasting purposes. A web page that is to be hosting the display is loaded and the player 24 downloaded or otherwise initiated at 300, and obtains a selected, scheduled or queued template 52 at 302. Based on the nature of the broadcast or using additional information such as that included in the metadata 54, the media content 48 to be combined is determined at 304. The media content 48 and template 52 are then combined, and any available real-time data updates are downloaded at 306. the real-time data updates (to be applied to the objects in the template 52) are then applied at 308, along with and rules and formatting involved in the broadcast or production in order to use the media content 48 as intended or scheduled. The media content 48 is then provided or played using the Silverlight™ template 52 at 310. While the content 48 is being played, the player 24 can check for new data, commands or other events that require new media content, new templates or new real-time data to be acquired at 312. It will be appreciated that the content is played at 310 until a predetermined event is encountered such as a time-out, receipt of an end command, expiration of content, according to a pre-set schedule, etc.

Although the invention has been described with reference to certain specific embodiments, various modifications thereof will be apparent to those skilled in the art without departing from the spirit and scope of the invention as outlined in the claims appended hereto.

1. A method for generating a template compatible with Microsoft Silverlight, said method comprising:
providing access to a Microsoft PowerPoint slide;
permitting objects to be added to said slide;
permitting properties of said objects to be defined;
converting said objects to a format associated with Silverlight to generate a template; and
generating metadata defining said properties for application of said properties to said template.

2. The method according to claim 1, wherein said converting comprises examining said objects to determine features of the slide and comparing said features to a set of criteria for determining equivalent features to be provided in said template.

3. The method according to claim 2, wherein said converting further comprises selecting corresponding Silverlight objects and populating said template with such objects, and said generating metadata further comprises appending said metadata to said template.

4. The method according to claim 3, wherein said template is generated in an extensible application mark-up language (XAML) format, and said metadata is generated in an extensible mark-up language (XML) format.

5. The method according to claim 1, further comprising providing a template authoring tool for selecting said objects to be added to said slide, said template authoring tool being provided as a separate application running in cooperation with an instance of Microsoft PowerPoint displaying said slide.

6. The method according to claim 1, further comprising enabling selection of one or more predefined smart objects comprising already one or more already prepared objects with built-in intelligence.

7. The method according to claim 1, further comprising enabling smart business or formatting rules or both to be applied to said slide.

8. The method according to claim 1, further comprising providing a data package comprising said template and said metadata to a web server to enable distribution of said template for use with a Silverlight player.

9. The method according to claim 8, wherein said web server comprises a web control interface for controlling what viewers see on said Silverlight player.

10. The method according to claim 8, further comprising providing said template to a media player on a resident device for providing content through said media player via said template.

11. A computer readable medium comprising computer executable instructions for generating a template compatible with Microsoft Silverlight, said computer readable medium comprising instructions for:
providing access to a Microsoft PowerPoint slide;
permitting objects to be added to said slide;
permitting properties of said objects to be defined;
converting said objects to a format associated with Silverlight to generate a template; and
generating metadata defining said properties for application of said properties to said template.

12. The computer readable medium according to claim 1, wherein said converting comprises examining said objects to determine features of the slide and comparing said features to a set of criteria for determining equivalent features to be provided in said template.

13. The computer readable medium according to claim 12, wherein said converting further comprises selecting corresponding Silverlight objects and populating said template with such objects, and said generating metadata further comprises instructions for appending said metadata to said template.

14. The computer readable medium according to claim 13, wherein said template is generated in an extensible application mark-up language (XAML) format, and said metadata is generated in an extensible mark-up language (XML) format.

15. The computer readable medium according to claim 11, further comprising instructions for providing a template authoring tool for selecting said objects to be added to said slide, said template authoring tool being provided as a separate application running in cooperation with an instance of Microsoft PowerPoint displaying said slide.

16. The computer readable medium according to claim 11, further comprising instructions for enabling selection of one or more predefined smart objects comprising already one or more already prepared objects with built-in intelligence.

17. The computer readable medium according to claim 11, further comprising instructions for enabling smart business or formatting rules or both to be applied to said slide.

18. The computer readable medium according to claim 11, further comprising instructions for providing a data package comprising said template and said metadata to a web server to enable distribution of said template for use with a Silverlight player.

19. The computer readable medium according to claim 18, wherein said web server comprises a web control interface for controlling what viewers see on said Silverlight player.

20. The computer readable medium according to claim 18, further comprising instructions for providing said template to a media player on a resident device for providing content through said media player via said template.

21. A system for generating a template compatible with Microsoft Silverlight, said system comprising an authoring workstation configured to be executed on a computer, said authoring workstation comprising computer executable instructions for providing an authoring application and a memory for storing media content to be added to said template, said authoring application being configured for: providing access to a Microsoft PowerPoint slide; permitting objects to be added to said slide; permitting properties of said objects to be defined; converting said objects to a format associated with Silverlight to generate a template; and generating metadata defining said properties for application of said properties to said template.
